(19) United States
(12) Patent Application Publication
(10) Pub. No.: US 2014/0060913 A1
(43) Pub. Date: Mar. 6, 2014

(54) S-SHIELD TWISTED PAIR CABLE DESIGN FOR MULTI-GHZ PERFORMANCE

(71) Applicants: Wayne Hopkinson, Hickory, NC (US); Trent Hayes, Hickory, NC (US); Daniel Parke, Hickory, NC (US); Douglas Brake, Denver, NC (US); David Wiebelhaus, Hickory, NC (US)

(72) Inventors: Wayne Hopkinson, Hickory, NC (US); Trent Hayes, Hickory, NC (US); Daniel Parke, Hickory, NC (US); Douglas Brake, Denver, NC (US); David Wiebelhaus, Hickory, NC (US)

(21) Appl. No.: 13/597,761

(22) Filed: Aug. 29, 2012

(51) Int. Cl. H01B 11/02; H01B 13/24; H01B 11/06

(52) U.S. Cl. 174/350; 174/113 R; 29/825

(57) ABSTRACT

A cable includes a jacket surrounding a cable core. The cable core includes four twisted pairs. An S-shaped separator separates two of the twisted pairs from the other two twisted pairs. The S-Shaped separator may be formed with two layers or three layers, wherein at least one layer is conductive. In alternative embodiments, one or both ends of the S-shaped separator make electrical contact to mid-portions of the separator to create one or two shielding cambers within the cable.

### BACKGROUND OF THE INVENTION

1. Field of the Invention

The present invention relates to a twisted pair cable for communication of high speed signals, such as a local area network (LAN) cable. More particularly, the present invention relates to a twisted pair cable having a separator tape between twisted pairs within the cable, which reduces or eliminates the likelihood of transmission errors because of internal or alien crosstalk, and hence allows for a relatively higher bit rate transmission.

2. Description of the Related Art

Along with the greatly increased use of computers for homes and offices, there has developed a need for a cable, which may be used to connect peripheral equipment to computers and to connect plural computers and peripheral equipment into a common network. Today's computers and peripherals operate at ever increasing data transmission rates. Therefore, there is a continuing need to develop a cable, which can operate substantially error-free at higher bit rates, by satisfying numerous elevated operational performance criteria, such as a reduction in internal and alien crosstalk when the cable is in a high cable density application. e.g. routed alongside other cables.

FIG. 1 shows a typical shielded twisted pair cable 1 and a twisting scheme employed for the four pairs of wires (a first pair A, a second pair B, a third pair C and a fourth pair D). A dielectric separator tape 3 separates twisted pairs A and C from twisted pairs B and D. The twisted pairs A, B, C and D in combination with the separator tape may be twisted in the direction of arrow 5 (e.g., opposite to the twist direction of the twisted pairs A, B, C and D) to form a stranded core. The stranded core is surrounded by a shielding layer 7. The shielding layer 7 may be formed of a conductive foil, and the foil's edges may partially overlap at area 9. A dielectric jacket 11 then surrounds the shielding layer 7.

Each twisted wire pair A, B, C and D includes two insulated conductors. Specifically, the first twisted wire pair A includes a first insulated conductor 13 and a second insulated conductor 15. The second twisted wire pair B includes a third insulated conductor 17 and a fourth insulated conductor 19. The third twisted wire pair C includes a fifth insulated conductor 21 and a sixth insulated conductor 23. The fourth twisted wire pair D includes a seventh insulated conductor 25 and an eighth insulated conductor 27.

Each twisted wire pair A, B, C and D is formed by having its two insulated conductors continuously twisted around each other. For the first twisted wire pair A, the first conductor 13 and the second conductor 15 twist completely about each other, three hundred sixty degrees, at a first interval w along the length of the cable 1. For the second twisted wire pair B, the third conductor 17 and the fourth conductor 19 twist completely about each other, three hundred sixty degrees, at a second interval x along the length of the cable 1. For the third twisted wire pair C, the fifth conductor 21 and the sixth conductor 23 twist completely about each other, three hundred sixty degrees, at a third interval y along the length of the cable 1. For the fourth twisted wire pair D, the seventh conductor 25 and the eighth conductor 27 twist completely about each other, three hundred sixty degrees, at a fourth interval z along the length of the cable 1.

Each of the wire pairs A, B, C and D has a fixed twist interval w, x, y, z, respectively. Each of the twist intervals w, x, y, z is different from the twist interval of the other wire pairs. As is known in the art, such an arrangement assists in reducing crosstalk between the wire pairs within the cable 1, which is referred to as internal crosstalk. In one embodiment of the prior art, each of the twisted wire pairs A, B, C and D has a unique fixed twist interval of slightly more than, or less than, 0.500 inches. Table 1 below summarizes the twist interval ranges for the twisted pairs A, B, C and D.

TABLE 1

| Twisted | Twist | Min. Twist | Max Twist |
|---|---|---|---|
| Pair | Length | Length | Length |
| A | 0.440 | 0.430 | 0.450 |
| B | 0.410 | 0.400 | 0.420 |
| C | 0.596 | 0.580 | 0.610 |
| D | 0.670 | 0.650 | 0.690 |

A cable 1, as described above and depicted in FIGS. 1 and 2, has enjoyed success in the industry. However, with the ever-increasing demand for faster data rate transmission speeds, it has become apparent, that the cable 1 of the prior art suffers drawbacks. For example, the background art's cable 1 exhibits unacceptable levels of internal and alien near end crosstalk at higher data transmission rates.

### SUMMARY OF THE INVENTION

Applicants have appreciated that at higher data transmission rates, the internal and alien crosstalk are more problematic. The crosstalk transmitted from, and received by, the pairs with the longer twist lengths are the most problematic. Therefore, in the prior art, the dielectric separator 3 is placed so as to separate and distance the two twisted pairs C and D with the longest twist lengths y and z. However, this technique of employing the separator 3 may be insufficient when the data transmission rate is increased.

Hence, a new cable structure to reduce the influences of internal and alien crosstalk is needed in the art as the data transmission rates are increased.

Applicants have invented a twisted pair cable with new structural features, the object of which is to enhance one or more performance characteristics of a LAN cable, such as reducing internal and alien crosstalk, insertion loss, matching impedance, reducing propagation delay and/or balancing delay skew between twisted pairs, and/or to enhance one or more mechanical characteristics of a LAN cable, such as improving flexibility, reducing weight, reducing cable diameter and/or reducing smoke emitted in the event of a fire.

These and other objects are accomplished by a cable that includes a jacket surrounding a cable core. The cable core includes four twisted pairs. An S-shaped separator separates two of the twisted pairs from the other two twisted pairs. The S-Shaped separator may be formed with two layers or three layers, wherein at least one layer is conductive. In alternative embodiments, one or both ends of the S-shaped separator make electrical contact to mid-portions of the separator to create one or two shielding cambers within the cable.

In a first alternative or supplemental embodiment of the invention, a cable includes: a first conductor; a first insulating material surrounding said first conductor to form a first insulated conductor; a second conductor; and a second insulating material surrounding said second conductor to form a second insulated conductor, wherein said first and second insulated conductors are twisted about each other to form a first twisted pair; a third conductor; a third insulating material surrounding said third conductor to form a third insulated conductor; a fourth conductor; and a fourth insulating material surrounding said fourth conductor to form a fourth insulated conductor, wherein said third and fourth insulated conductors are twisted about each other to form a second twisted pair; a fifth conductor; a fifth insulating material surrounding said fifth conductor to form a fifth insulated conductor; a sixth conductor; and a sixth insulating material surrounding said sixth conductor to form a sixth insulated conductor, wherein said fifth and sixth insulated conductors are twisted about each other to form a third twisted pair; a seventh conductor; a seventh insulating material surrounding said seventh conductor to form a seventh insulated conductor; an eighth conductor; and an eighth insulating material surrounding said eighth conductor to form an eighth insulated conductor, wherein said seventh and eighth insulated conductors are twisted about each other to form a fourth twisted pair; a jacket surrounding said first, second, third and fourth twisted pairs, said first and third twisted pairs residing in approximately a first half of said cable, and said second and fourth twisted pairs residing in approximately a second half of said cable, wherein a region between said first and second halves of said cable defines a middle region; and a tape separator disposed within jacket, and separating said first and third twisted pairs from said second and fourth twisted pairs, said tape separator having a first edge and an opposite second edge, said first edge being disposed proximate said middle region, wherein said tape separator extends from said first edge partially around said second and fourth twisted pairs, through said middle region, partially around said first and third twisted pairs, and ends at said second edge, wherein said second edge is located proximate said middle region.

In a second alternative or supplemental embodiment of the invention, a cable includes: a first twisted pair; a second twisted pair; a third twisted pair; a fourth twisted pair; a jacket surrounding said first, second, third and fourth twisted pairs, said first and third twisted pairs residing in approximately a first half of said cable, and said second and fourth twisted pairs residing in approximately a second half of said cable, wherein a region between said first and second halves of said cable defines a middle region; and a conductive tape separator disposed within jacket, and separating said first and third twisted pairs from said second and fourth twisted pairs, said tape separator having a first edge, said first edge being disposed proximate said middle region, wherein said tape separator extends from said first edge partially around said second and fourth twisted pairs, and through said middle region.

In a third alternative or supplemental embodiment of the invention, a method of making a cabling includes: twisting a first insulated conductor and a second insulated conductor to form a first twisted pair; twisting a third insulated conductor and a fourth insulated conductor to form a second twisted pair; twisting a fifth insulated conductor and a sixth insulated conductor to form a third twisted pair; twisting a seventh insulated conductor and an eight insulated conductor to form a fourth twisted pair; inserting a tape separator amongst the first, second, third and fourth twisted pairs so as to separate the first and third twisted pairs from the second and fourth twisted pairs; and extruding a jacket around the first, second, third and fourth twisted pairs and tape separator to form the cable, wherein the first and third twisted pairs reside in approximately a first half of the cable, and the second and fourth twisted pairs residing in approximately a second half of the cable, wherein a region between the first and second halves of the cable defines a middle region, characterized by, the separator having a first edge and an opposite second edge, and said inserting proceeds so that the first edge is disposed proximate the middle region, wherein the tape separator extends from the first edge partially around the second and fourth twisted pairs, through the middle region, partially around the first and third twisted pairs, and ends at the second edge, wherein the second edge is located proximate the middle region.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of a shielded, twisted pair cable, in accordance with the prior art;

FIG. 2 is a cross sectional view taken along line II—II in FIG. 1;

FIG. 3 is a perspective view of a twisted pair cable, in accordance with a first embodiment of the present invention;

FIG. 4 is a cross sectional view taken along line IV—IV in FIG. 3;

FIG. 5 is a cross sectional view taken along line V—V in FIGS. 4 and 9;

FIG. 6 is a cross sectional view, similar to FIG. 4, but showing a twisted pair cable, in accordance with a second embodiment of the present invention;

FIG. 7 is a cross sectional view taken along line VII—VII in FIGS. 6, 8 and 10;

FIG. 8 is a cross sectional view, similar to FIG. 6, but showing a twisted pair cable, in accordance with a third embodiment of the present invention;

FIG. 9 is a cross sectional view, similar to FIG. 8, but showing a twisted pair cable, in accordance with a fourth embodiment of the present invention;

FIG. 10 is a cross sectional view, similar to FIG. 8, but showing a twisted pair cable, in accordance with a fifth embodiment of the present invention; and

FIG. 11 is a cross sectional view, similar to FIG. 8, but showing a twisted pair cable, in accordance with a sixth embodiment of the present invention.

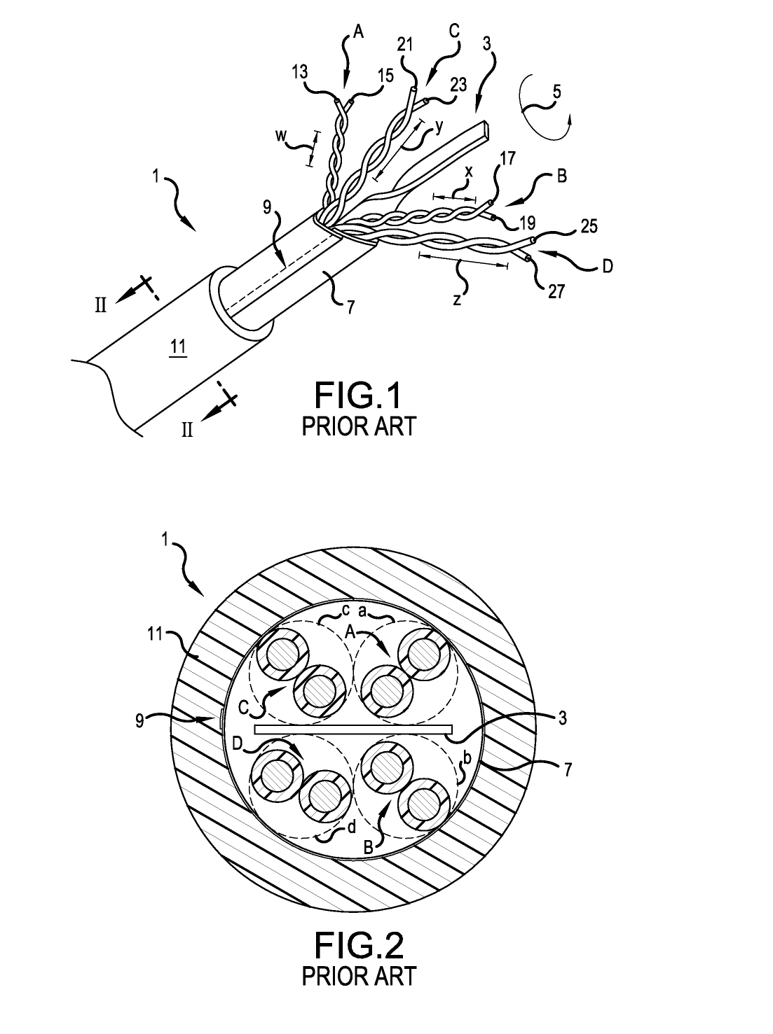

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

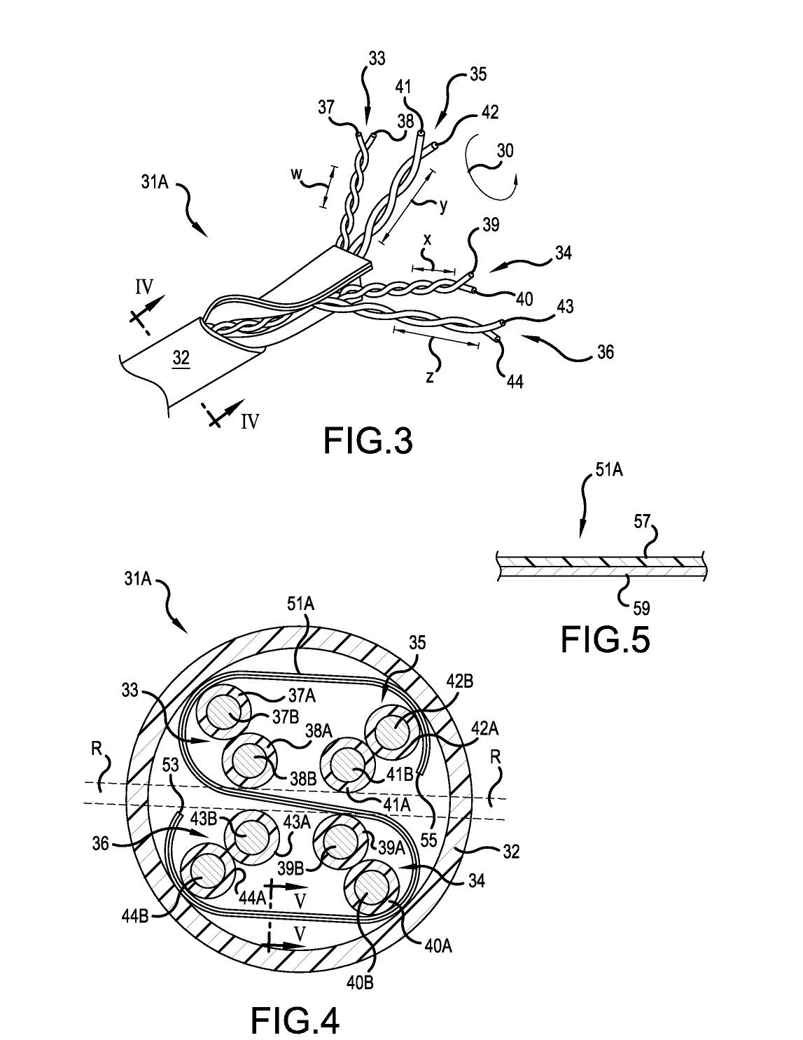

FIG. 3 is a perspective view of a twisted pair cable 31A, in accordance with a first embodiment of the present invention. FIG. 4 is a cross sectional view of the cable 31A taken along line IV—IV in FIG. 3. The cable 31A includes a jacket 32 formed around and surrounding a cable core. The cable core includes first, second, third and fourth twisted pairs 33, 34, 35 and 36, respectively. The jacket 32 may be formed of polyvinylchloride (PVC), low smoke zero halogen PVC, polyethylene (PE), fluorinated ethylene propylene (FEP), polyvinylidene fluoride (PVDF), ethylene chlorotrifluoroethylene (ECTFE), or other foamed or solid materials common to the cabling art.

The first twisted pair 33 includes a first insulated conductor 37 formed by a first insulating material 37A surrounding a first conductor 37B, and a second insulated conductor 38 formed by a second insulating material 38A surrounding a second conductor 38B, wherein said first and second insulated conductors 37 and 38 are twisted about each other to form the first twisted pair 33.

The second twisted pair 34 includes a third insulated conductor 39 formed by a third insulating material 39A surrounding a third conductor 39B, and a fourth insulated conductor 40 formed by a fourth insulating material 40A surrounding a fourth conductor 40B, wherein said third and fourth insulated conductors 39 and 40 are twisted about each other to form the second twisted pair 34.

The third twisted pair 35 includes a fifth insulated conductor 41 formed by a fifth insulating material 41A surrounding a fifth conductor 41B, and a sixth insulated conductor 42 formed by a sixth insulating material 42A surrounding a sixth conductor 42B, wherein said fifth and sixth insulated conductors 41 and 42 are twisted about each other to form the third twisted pair 35.

The fourth twisted pair 36 includes a seventh insulated conductor 43 formed by a seventh insulating material 43A surrounding a seventh conductor 43B, and an eighth insulated conductor 44 formed by an eighth insulating material 44A surrounding an eighth conductor 44B, wherein said seventh and eighth insulated conductors 43 and 44 are twisted about each other to form the fourth twisted pair 36.

The twist lengths w, x, y and z of the first, second, third and fourth twisted pairs 33, 34, 35 and 36 may be the same as listed in Table 1 for twisted pairs A, B, C and D, respectively. For example, a first twist length w of the first twisted pair 33 may be shorter than a third twist length y of the third twisted pair 35, and a second twist length x of the second twisted pair 34 may be shorter than a fourth twist length z of the fourth twisted pair 36. It should be noted that other twist lengths than those listed in Table 1 may be employed while practicing the benefits of the present invention.

The first through eighth insulating materials 37A-44A may be formed of a flexible plastic material having flame retardant and smoke suppressing properties, such as a polymer or foamed polymer, common to the cabling art, like fluorinated ethylene propylene (FEP), polyethylene (PE) or polypropylene (PP). A radial thickness of the first through eighth insulating materials 37A-44A would typically be greater than seven mils, such as about tens mils or about eleven mils. The first through eighth conductors 37B-44B may be solid or stranded, and may be formed of a conductive metal or alloy, such as copper. In one embodiment, the first through eighth conductors 37B-44B are each a solid, copper wire of about twenty three gauge size.

In one embodiment of the invention, the first and third twisted pairs 33 and 35 reside in approximately a first half of the cable 31A, and the second and fourth twisted pairs 34 and 36 reside in approximately a second half of the cable 31A. A region R between the first and second halves of the cable 31A defines a middle region.

A separator tape 51A is located within the jacket 32 and separates the first and third twisted pairs 33 and 35 from the second and fourth twisted pairs 34 and 36. The tape separator 51A has a first edge 53 and an opposite second edge 55. The first and second edges extend in a same direction as an extension length of the cable 31A. The first edge 53 is disposed proximate the middle region R and the fourth twisted pair 36. The tape separator 51A extends from the first edge 53 partially around the fourth twisted pair 36, then partially around the second twisted pair 34, through said middle region R, then partially around the first twisted pair 33, then partially around the third twisted pair 35, and ends at the second edge 55, wherein the second edge 55 is located proximate the middle region R and the third twisted pair 35. The resulting cross sectional shape of the separator tape 51A is S-shaped.

Of course, the S-shape shown in FIG. 4 could be a mirror image about a vertical mid-axis, to make a backwards S-shape. In such configuration, the first edge 53 is disposed proximate the middle region R and the second twisted pair 34. The tape separator 51A would extend from the first edge 53 partially around the second twisted pair 34, then partially around the fourth twisted pair 36, through said middle region R, then partially around the third twisted pair 35, then partially around the first twisted pair 33, and then end at the second edge 55, wherein the second edge 55 would be located proximate the middle region R and the first twisted pair 33. Both the forwards and backwards S-shapes are intended to be covered by a phase reciting that the tape separator passes “partially around said second and fourth twisted pairs.” In other words, listing the word “second” before the word “fourth” does not imply that the separator tape passes around the second twisted pair before passing around the fourth twisted pair.

As seen in FIG. 3, the cable core may be twisted in the direction of arrow 30 to form a core strand. In the illustrated embodiment, the direction 30 is opposite to the twist directions of the first, second, third and fourth twisted pairs 33, 34, 35 and 36 and may offer advantages as discussed in the Assignee's U.S. Pat. No. 6,770,819, which is incorporated herein by reference. However, this is not a necessary feature, as the benefits of the present invention will still be apparent with the core strand's direction 30 being the same as the pair twist directions. The core strand length may be approximately 4 inches, although other lengths may be employed within the spirit of the present invention.

FIG. 5 is a cross sectional view taken along line V—V in FIG. 4. FIG. 5 shows the construction of the tape separator 51A. The tape separator 51A is formed of a first layer 57 and a second layer 59. The first layer 57 is nonconductive and the second layer 59 is conductive. In one embodiment, the first layer 57 is formed of a polyester film, and the second layer 59 is formed of a conductive foil. One suitable material for the polyester film is biaxially-oriented polyethylene terephthalate, e.g., Mylar®, and one suitable material for the conductive foil is aluminum, although other materials may be selected. Suitable thicknesses might be less than 1 mil for each of the first and second layers 57 and 59.

The nonconductive, first layer 57 provides strength, while the conductive, second layer 59 provides the s-shaped tape with its shielding qualities. Hence, the tape separator 51A has electrically conductive properties to shield the first and third twisted pairs 33 and 35 from the second and fourth twisted pairs 34 and 36. This arrangement greatly reduces the occurrence of internal crosstalk in the cable.

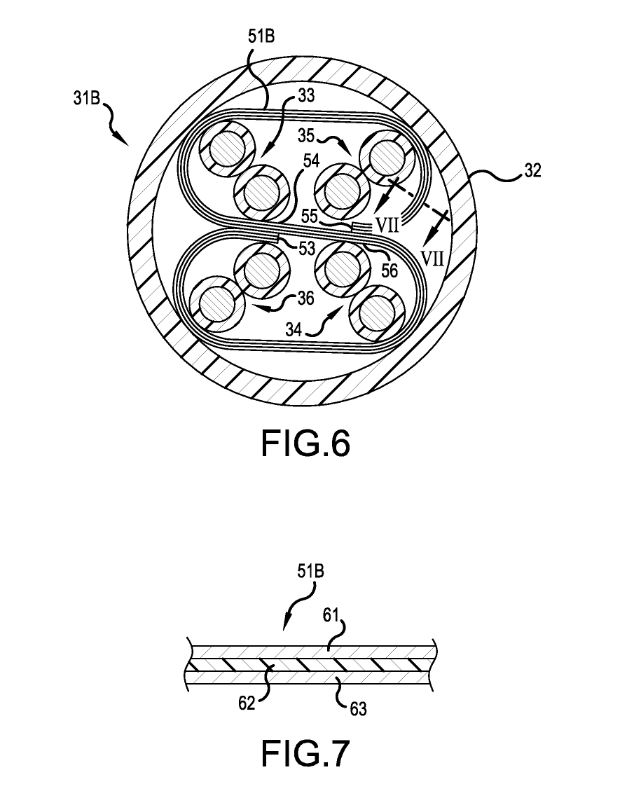

FIG. 6 is a cross sectional view, similar to FIG. 4, but showing a twisted pair cable 31B, in accordance with a second embodiment of the present invention. In the second embodiment, the first edge 53 of a tape separator 51B is in electrical contact with a first mid-portion 54 of the tape separator 51B proximate the middle region R. Also, the second edge 55 of the tape separator 51B is in electrical contact with a second mid-portion 56 of the tape separator 51B proximate the middle region R. The electric contact will be better understood with reference to FIG. 7.

FIG. 7 is a cross sectional view taken along line VII—VII in FIG. 6. The tape separator 51B is formed of at least three layers. A first layer 61 being conductive, a second layer 62 being nonconductive, and a third layer 63 being conductive. The second layer 62 is located between the first layer 61 and the third layer 63. The materials used for the conductive, first and third layers 61 and 63, and the non-conductive, second layer 62 may be the same as the materials described in conjunction with FIG. 5.

As illustrated in FIG. 6, the first layer 61 at the first edge 53 of the tape separator 51B is in electrical contact with the third layer 63 at the first mid-portion 54 of the tape separator 51B proximate the middle region R. Also, the third layer 63 at the second edge 55 of the tape separator 51B is in electrical contact with the first layer 61 at the second mid-portion 56 of the tape separator 51B proximate the middle region R. By this arrangement, alien crosstalk is greatly reduced. In other words, the signals of the first, second, third and fourth twisted pairs are shielded from signals of twisted pairs in other adjacent cables.

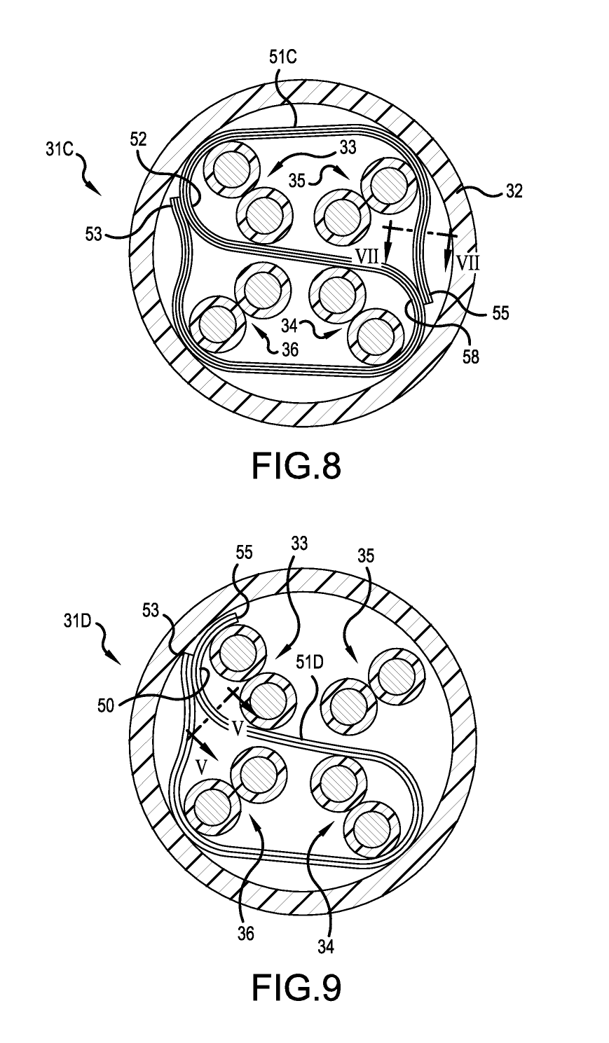

FIG. 8 is a cross sectional view, similar to FIG. 6, but showing a twisted pair cable 31C, in accordance with a third embodiment of the present invention. The differences between FIGS. 8 and 6 are that the first edge 53 and second edge 55 of a separator tape 51C are not tucked into the middle region R for electrically contacting the first and second mid-portions 54 and 56 of the separator tape 51C. Rather, the first edge 53 is in electrical contact with a third portion 52 of the separator tape 51C within the first half of the cable 31C, and the second edge 55 is in electrical contact with a fourth portion 58 of the separator tape 51C within the second half of the cable 31C.

As illustrated in FIG. 8, the third layer 63 at the first edge 53 of the tape separator 51C is in electrical contact with the third layer 63 at the third portion 52 of the tape separator 51C. Also, the first layer 61 at the second edge 55 of the tape separator 51C is in electrical contact with said first layer 61 at the fourth portion 58 of the tape separator 51C.

FIG. 9 is a cross sectional view, similar to FIG. 8, but showing a twisted pair cable 31D, in accordance with a fourth embodiment of the present invention. The differences between FIGS. 9 and 8 are that the first edge 53 and second edge 55 of the separator tape 51D are differently located. The first edge 53 is in electrical contact with a fifth portion 50 of the separator tape 51D within the first half of the cable 31D, and the second edge 55 is in not in electrical contact with any other portion of the separator tape 51D. Also, the separator tape 51D may be a two layer version as illustrated in the cross sectional view of FIG. 5. As illustrated in FIG. 9, the conductive second layer 59 at the first edge 53 of the tape separator 51D is in electrical contact with the same conductive, second layer 59 at the fifth portion 50 of the tape separator 51D.

In the embodiments of FIGS. 4, 6, 8 and 9, the first and third twisted pairs 33 and 35 are shielded from the second and fourth twisted pairs 34 and 36. Hence, it is no longer necessary to have four different twist lengths within a cable to reduce the internal crosstalk. Rather, it is only required to have two different twist lengths employed in the cable. For example, the first twist length w may equal the second twist length x, and the third twist length y may equal the fourth twist length z.

Such an arrangement offers several advantages. First, there are more design freedoms in the cable to tune the cable to a specific performance characteristic. When the cable required four different twist lengths, there was a minimum twist length w, a maximum twist length Z, and two different intermediate twist lengths x and y. The smaller twist length w was paired with the larger intermediate twist length y on one side of the separator 3, and the largest twist length z was paired with the smaller intermediate twist length x on the other side of the separator 3. This pairing was a compromise that allowed for a sufficient difference in the twist lengths for twisted pairs that were on a same side of the separator 3. The cable would have performed poorly if the smallest twist length w and the largest twist length z were deployed on one side of the separator 3, and the two intermediate twist lengths x and y were deployed on the other side of the separator 3 because the twist length difference between the two intermediate twist lengths x and y would have been insufficient to prevent internal crosstalk between the two twisted pairs 34 and 35 at high data speeds.

With the cables of the present invention, one could employ the smallest twist length w adjacent to the longest twist length z on one side of the separator 51. Because of the greater difference in twist lengths the internal crosstalk between the two grouped twisted pairs should be relatively improved as compared to the prior art situation where the smallest twist length w was paired with the larger intermediate twist length y. Since, the separator 51 completely isolates the first and third twisted pairs 33 and 35 from the second and fourth twisted pairs 34 and 36, the two twisted pairs on the other side of the separator 51 can also employ twist lengths of w and z, respectively.

A second advantage is that there are fewer “types” of twisted pairs used in the cable. In the prior art, a cable manufacturer needs to assemble and store twisted pairs having four different twist lengths, e.g., twist lengths of w, x, y and z. In the cable of the present invention, the cable manufacturer needs to only manufacture and store twisted pairs having two different twist lengths, e.g., w and z, or perhaps w and y.

FIG. 4 illustrates a cable design wherein the first and third twisted pairs 33 and 35 are shielded from the second and fourth twisted pairs 34 and 36 to reduce internal crosstalk between the twisted pairs 33 and 35 in the first half of the cable 31A to one side of the separator tape 51A from the twisted pairs 34 and 36 in the other half of the cable 31A on the other side of the separator tape 51A. In testing, the cable 31A of FIG. 4 exhibited some issues with alien crosstalk. Most likely due to the air gap where the first edge 53 of the separator tape 51A fails to contact any mid-portion of the separator tape 51A, and the similarly formed air gap adjacent to the second edge 55 of the separator tape 51A.

The embodiments of FIGS. 6 and 8 close the air gaps, such that the separator tapes 51B and 51C form complete shields around the first and third twisted pairs 33 and 35, and around the second and fourth twisted pairs 34 and 36. The air gaps were removed to improve performance in alien crosstalk for higher data rates/signal speeds. However, it should be appreciated that the embodiment of FIG. 4 uses less material and may be suitable for cabling having certain performance criteria, e.g., reduced data rates/signal speeds.

The embodiment of FIG. 9 has the same advantages as FIGS. 4, 6 and 8 regarding the reduction of internal crosstalk, in that the separator tapes 51D completely shields the second and fourth twisted pairs 34 and 36 from the first and third twisted pairs 33 and 35. However, the embodiment of FIG. 9 does not completely shield the first and third twisted pairs 33 and 35 from other twisted pairs in other cables. Hence, it should be expected that the alien crosstalk performance of the embodiment of FIG. 9 would be inferior to that of the embodiments of FIGS. 4, 6 and 8. It should be appreciated that the embodiment of FIG. 9 uses less material and may be suitable for cabling having certain performance criteria, such as a cabling situation where adjacent cables and interference would not exist, and alien crosstalk would not be an issue, e.g., bundled alongside fiber optic cables within a conduit. Also, the alien crosstalk performance could be enhanced by employing a striated jacket, as shown in U.S. Pat. No. 5,796,046 and published U.S. Application 2005/0133246, both of which are herein incorporated by reference. The alien crosstalk performance could be further enhanced by employing twist modulation and/or core strand modulation, as shown in the Assignee's U.S. Pat. No. 6,875,928, which is incorporated herein by reference.

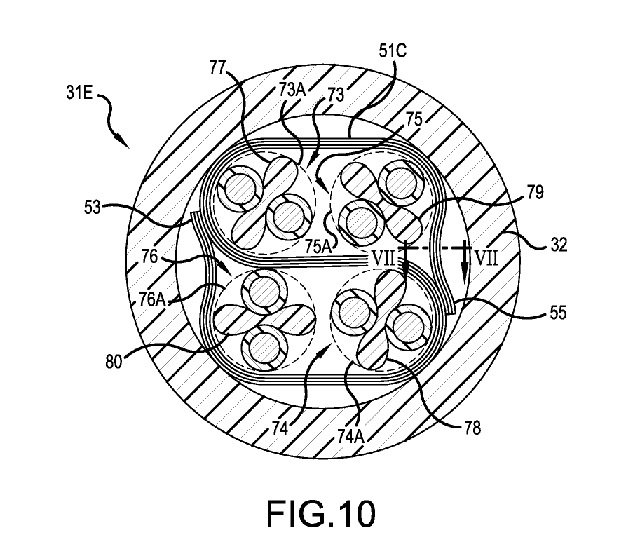

FIG. 10 is a cross sectional view, similar to FIG. 8, but showing a twisted pair cable 31E, in accordance with a fifth embodiment of the present invention. The first, second, third and fourth twisted pairs 33, 34, 35 and 36 have been replaced with twisted pairs 73, 74, 75, and 76. The new twisted pair design allows the insulation layer surrounding the conductors to be made thinner (e.g., less than 7 mils, such as 5 or 6 mils in radial thickness), which can lead to improvements in cable performance as detailed in the Assignee's prior U.S. Pat. No. 7,999,184, which is incorporated herein by reference.

In the embodiment of FIG. 10, impedance matching and structural integrity in each twisted pair 73, 74, 75 and 76 are maintained by a small dielectric tape interposed between the two insulated conductors forming the twisted pair. Specifically, a first dielectric tape 77 is interposed between first and second insulated conductors, as the first and second insulated conductors are twisted about each other to form the first twisted pair 73. A second dielectric tape 78 is interposed between third and fourth insulated conductors, as the third and fourth insulated conductors are twisted about each other to form the second twisted pair 74. A third dielectric tape 79 is interposed between fifth and sixth insulated conductors, as the fifth and sixth insulated conductors are twisted about each other to form the third twisted pair 75. A fourth dielectric tape 80 is interposed between seventh and eighth insulated conductors, as the seventh and eighth insulated conductors are twisted about each other to form the fourth twisted pair 76.

Although a thin layer of insulation is shown on each of the conductors of the twisted pairs 73, 74, 75 and 76, it would be possible to use bare conductors (without an insulating layer and then wrap a thin layer of insulating material around each twisted pair along the dashed lines 73A, 74A, 75A and 76A. Although FIG. 10 depicts a particular shape for the dielectric tapes 77, 78, 79 and 80, other shapes may be employed, such as those shown in the above mentioned U.S. Pat. No. 7,999,184.

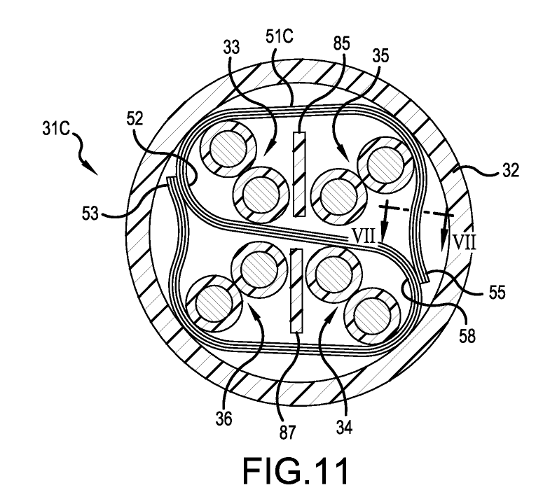

FIG. 11 is a cross sectional view, similar to FIG. 8, but showing a twisted pair cable 31C′, in accordance with a sixth embodiment of the present invention. The structure of the cable in accordance with the sixth embodiment is the same as the structure of the cable in accordance with the third embodiment, except that a first separator tape 85 may be added between the first and third twisted pairs 33 and 35, and/or a second separator tape 87 may be added between the second and fourth twisted pairs 34 and 36.

The first separator tape 85 may be added if the internal crosstalk between the first and third twisted pairs 33 and 35 needs to be improved for a desired level of cable performance. The second separator tape 87 may be added if the internal crosstalk between the second and fourth twisted pairs 34 and 36 needs to be improved for a desired level of cable performance. Although FIG. 11 shows two separator tapes 85 and 87, only one of the separator tapes 85 or 87 may be needed to deal with an internal crosstalk performance issue.

The separator tapes 85 and/or 87 may also be employed in the other embodiments of the present invention, such as in the cables depicted in FIGS. 4, 6, 9 and 10. In the instance of FIG. 10, the separator tapes 85 and/or 87 could be used to provide separation between the twisted pairs. Alternatively, the first, second, third and fourth dielectric tapes 77, 78, 79 and 80 may be extended in length to provide increased pair-to-pair spacing, as is detailed in U.S. Pat. No. 7,999,184, previously incorporated herein by reference. It would also be possible to increase pair-to-pair spacing by employing both a tape separator 85 and/or 87 and an extended length first, second, third and/or fourth dielectric tapes 77, 78, 79 and/or 80.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. A cable comprising:
a first conductor; a first insulating material surrounding said first conductor to form a first insulated conductor; a second conductor; and a second insulating material surrounding said second conductor to form a second insulated conductor, wherein said first and second insulated conductors are twisted about each other to form a first twisted pair;
a third conductor; a third insulating material surrounding said third conductor to form a third insulated conductor; a fourth conductor; and a fourth insulating material surrounding said fourth conductor to form a fourth insulated conductor, wherein said third and fourth insulated conductors are twisted about each other to form a second twisted pair;
a fifth conductor; a fifth insulating material surrounding said fifth conductor to form a fifth insulated conductor; a sixth conductor; and a sixth insulating material surrounding said sixth conductor to form a sixth insulated conductor, wherein said fifth and sixth insulated conductors are twisted about each other to form a third twisted pair;
a seventh conductor; a seventh insulating material surrounding said seventh conductor to form a seventh insulated conductor; an eighth conductor; and an eighth insulating material surrounding said eighth conductor to form an eighth insulated conductor, wherein said seventh and eighth insulated conductors are twisted about each other to form a fourth twisted pair;
a jacket surrounding said first, second, third and fourth twisted pairs, said first and third twisted pairs residing in approximately a first half of said cable, and said second and fourth twisted pairs residing in approximately a second half of said cable, wherein a region between said first and second halves of said cable defines a middle region; and
a tape separator disposed within jacket, and separating said first and third twisted pairs from said second and fourth twisted pairs, said tape separator having a first edge and an opposite second edge, said first edge being disposed proximate said middle region, wherein said tape separator extends from said first edge partially around said second and fourth twisted pairs, through said middle region, partially around said first and third twisted pairs, and ends at said second edge, wherein said second edge is located proximate said middle region.

2. The cable according to claim 1, wherein said tape separator has electrically conductive properties to shield said first and third twisted pairs from said second and fourth twisted pairs.

3. The cable according to claim 2, wherein said first edge of said tape separator is in electrical contact with a first mid-portion of said tape separator proximate said middle region.

4. The cable according to claim 3, wherein said second edge of said tape separator is in electrical contact with a second mid-portion of said tape separator proximate said middle region.

5. The cable according to claim 4, wherein said tape separator is formed of at least three layers, with a first layer being conductive, a second layer being nonconductive, and a third layer being conductive, and wherein said second layer is located between said first and third layers.

6. The cable according to claim 5, wherein said first layer at said first edge of said tape separator is in electrical contact with said third layer at said first mid-portion of said tape separator proximate said middle region, and wherein said third layer at said second edge of said tape separator is in electrical contact with said first layer at said second mid-portion of said tape separator proximate said middle region.

7. The cable according to claim 1, wherein a first twist length of said first twisted pair is shorter than a third twist length of said third twisted pair, and a second twist length of said second twisted pair is shorter than a fourth twist length of said fourth twisted pair.

8. The cable according to claim 7, wherein said first twist length equals said second twist length.

9. The cable according to claim 8, wherein said second twist length equals said fourth twist length.

10. The cable according to claim 1, wherein said separator tape is formed of at least two layers, with a first layer being conductive and a second layer being nonconductive.

11. The cable according to claim 10, wherein said first layer is formed of a polyester film, and said second layer is formed of a conductive foil.

12. The cable according to claim 1, wherein said tape separator has said first edge disposed proximate said middle region and said fourth twisted pair, wherein said tape separator extends from said first edge partially around said fourth twisted pair, then partially around said second twisted pair, through said middle region, then partially around said first twisted pair, and then partially around said third twisted pair, and ends at said second edge, wherein said second edge is located proximate said middle region and said third twisted pair.

13. The cable according to claim 1, wherein a first dielectric tape is interposed between said first insulated conductor and said second insulated conductor, as said first and second insulated conductors are twisted about each other to form said first twisted pair; and
wherein a third dielectric tape is interposed between said fifth insulated conductor and said sixth insulated conductor, as said fifth and sixth insulated conductors are twisted about each other to form said third twisted pair.

14. The cable according to claim 13, wherein a second dielectric tape is interposed between said third insulated conductor and said fourth insulated conductor, as said third and fourth insulated conductors are twisted about each other to form said second twisted pair; and
wherein a fourth dielectric tape is interposed between said seventh insulated conductor and said eighth insulated conductor, as said seventh and eighth insulated conductors are twisted about each other to form said fourth twisted pair.

15. A cable comprising:
a first twisted pair;
a second twisted pair;
a third twisted pair;
a fourth twisted pair;
a jacket surrounding said first, second, third and fourth twisted pairs, said first and third twisted pairs residing in approximately a first half of said cable, and said second and fourth twisted pairs residing in approximately a second half of said cable, wherein a region between said first and second halves of said cable defines a middle region; and
a conductive tape separator disposed within jacket, and separating said first and third twisted pairs from said second and fourth twisted pairs, said tape separator having a first edge, said first edge being disposed proximate said middle region, wherein said tape separator extends from said first edge partially around said second and fourth twisted pairs, and through said middle region.

16. The cable according to claim 15, wherein said first edge of said tape separator is in electrical contact with a first mid-portion of said tape separator proximate said middle region.

17. The cable according to claim 15, wherein a first twist length of said first twisted pair is shorter than a third twist length of said third twisted pair, and a second twist length of said second twisted pair is shorter than a fourth twist length of said fourth twisted pair.

18. The cable according to claim 17, wherein said first edge of said tape separator is in electrical contact with a first mid-portion of said tape separator proximate said middle region to shield said second and fourth twisted pairs from said first and third twisted pairs, and wherein said first twist length equals said third twist length, and said third twist length equals said fourth twist length.

19. The cable according to claim 15, wherein a first dielectric tape is interposed between a first conductor and a second conductor, as said first and second conductors are twisted about each other to form said first twisted pair;
wherein a second dielectric tape is interposed between a third conductor and a fourth conductor, as said third and fourth conductors are twisted about each other to form said second twisted pair;
wherein a third dielectric tape is interposed between a fifth conductor and a sixth conductor, as said fifth and sixth conductors are twisted about each other to form said third twisted pair; and
wherein a fourth dielectric tape is interposed between a seventh conductor and an eighth conductor, as said seventh and eighth conductors are twisted about each other to form said fourth twisted pair.

20. A method of making a cabling comprising:
twisting a first insulated conductor and a second insulated conductor to form a first twisted pair;
twisting a third insulated conductor and a fourth insulated conductor to form a second twisted pair;
twisting a fifth insulated conductor and a sixth insulated conductor to form a third twisted pair;
twisting a seventh insulated conductor and an eight insulated conductor to form a fourth twisted pair;
inserting a tape separator amongst the first, second, third and fourth twisted pairs so as to separate the first and third twisted pairs from the second and fourth twisted pairs; and
extruding a jacket around the first, second, third and fourth twisted pairs and tape separator to form the cable, wherein the first and third twisted pairs reside in approximately a first half of the cable, and the second and fourth twisted pairs residing in approximately a second half of the cable, wherein a region between the first and second halves of the cable defines a middle region,
characterized by, the separator having a first edge and an opposite second edge, and said inserting proceeds so that the first edge is disposed proximate the middle region, wherein the tape separator extends from the first edge partially around the second and fourth twisted pairs, through the middle region, partially around the first and third twisted pairs, and ends at the second edge, wherein the second edge is located proximate the middle region.
